(19) United States
(12) Patent Application Publication
(10) Pub. No.: US 2015/0163331 A1
(43) Pub. Date: Jun. 11, 2015

(54) PACKET CONTROL METHOD AND APPARATUS

(71) Applicant: HUAWEI TECHNOLOGIES CO., LTD., Shenzhen (CN)

(72) Inventors: Hui NI, Beijing (CN); Shiyong TAN, Beijing (CN); Hui CAl, Shenzhen (CN)

(73) Assignee: HUAWEI TECHNOLOGIES CO., LTD., Shenzhen (CN)

(21) Appl. No.: 14/626,402

(22) Filed: Feb. 19, 2015

Related U.S. Application Data
(63) Continuation of application No. PCT/CN2012/080514, filed on Aug. 23, 2012.

(51) Int. Cl. H04L 29/06

(52) U.S. Cl. CPC H04L 69/22

(57) ABSTRACT

The present invention relates to a packet control method. The method includes: sending a packet parse request that includes a to-be-parsed packet to a deep packet inspection DPI serving network element, so that the deep packet inspection DPI serving network element performs deep packet inspection on the to-be-parsed packet and acquires application identifier information corresponding to the to-be-parsed packet; receiving a packet parse response message that includes the application identifier information and is sent by the deep packet inspection DPI device; searching for a service control policy corresponding to the application identifier information; and performing service control on the packet according to the service control policy. In embodiments of the present invention, an application layer keyword matching logic of a DPI requesting network element does not need to be changed, so that implementation complexity of the DPI requesting network element is reduced.

### CROSS-REFERENCE

This application is a continuation of International Application No. PCT/CN2012/080514, filed on Aug. 23, 2012, which is hereby incorporated by reference in its entirety.

### TECHNICAL FIELD

The present invention relates to the internet field, and in particular, to a packet control method and apparatus.

### BACKGROUND

An existing DPI device is a customized device deployed by each manufacturer according to an operator requirement. Referring to FIG. 1, an existing process of implementing service control based on a DPI function is as follows: First, a DPI requesting network element sends a to-be-parsed packet to a corresponding DPI device according to preconfigured DPI device addressing information by using a packet parse request message; then, the DPI device performs deep service identification and parsing on the to-be-parsed packet, and returns a packet keyword obtained by parsing to the DPI requesting network element by using a response message; finally, the DPI requesting network element matches the returned packet keyword with a predefined service feature keyword, and after keyword information is matched, the DPI requesting network element acquires a corresponding service control policy, and performs, according to the service control policy, service control, for example, operations such as gating, QoS control, bandwidth control, redirection, and charging.

In the foregoing technology, a parsing result returned by the DPI device is closely related to a specific application type. The DPI requesting network element is responsible for determining a service type according to a keyword; when upgrade of an application layer protocol is changed, the DPI requesting network element always needs to modify a corresponding application layer keyword matching logic, which makes it relatively complex to implement the DPI requesting network element.

### SUMMARY

An objective of the present invention is to provide a packet control method and apparatus, so as to implement an application-based service control policy when a DPI requesting network element does not need to sense specific application content of a to-be-parsed packet.

According to one aspect, an embodiment of the present invention provides a packet control method, where the method includes:

sending a packet parse request to a deep packet inspection DPI serving network element, where the packet parse request includes a to-be-parsed packet, so that the DPI serving network element performs deep packet inspection on the to-be-parsed packet according to the packet parse request, and acquires application identifier information corresponding to the to-be-parsed packet;

receiving a packet parse response message sent by the DPI serving network element, where the packet parse response message includes the application identifier information;

searching for a service control policy corresponding to the application identifier information; and

performing service control on a subsequent packet according to the service control policy.

In a first possible implementation manner, the acquiring application identifier information corresponding to the to-be-parsed packet specifically includes:

sending a service control policy request message that includes the application identifier information to a control gateway, so that the control gateway acquires the service control policy corresponding to the application identifier information;

receiving a service control policy response message that includes the service control policy and is sent by the control gateway; and

acquiring the service control policy according to the service control policy response message.

In a second possible implementation manner, before the sending a packet parse request that includes a to-be-parsed packet to a deep packet inspection DPI serving network element, the method further includes: configuring a correspondence between application identifier information and a service control policy at a local end; and

the searching for a service control policy corresponding to the application identifier information specifically includes:

searching, according to the correspondence between application identifier information and a service control policy, for the service control policy corresponding to the application identifier information.

According to another aspect, an embodiment of the present invention provides a packet parsing method, where the method includes:

receiving a packet parse request sent by a deep packet inspection DPI requesting network element, where the packet parse request includes a to-be-parsed packet;

parsing the to-be-parsed packet according to the packet parse request, and acquiring application identifier information corresponding to the to-be-parsed packet; and

sending a packet parse response message to the DPI requesting network element, where the packet parse response message includes the application identifier information, so that the DPI requesting network element searches for a service control policy corresponding to the application identifier information.

In a first possible implementation manner, the acquiring application identifier information corresponding to the to-be-parsed packet specifically includes:

sending an application identifier request to an application identifier gateway according to a parsing result obtained by parsing the to-be-parsed packet; and

receiving application identifier response information that includes the application identifier information and is returned by the application identifier gateway.

In a second possible implementation manner, before the parsing the to-be-parsed packet and acquiring application identifier information corresponding to the to-be-parsed packet, the method further includes: locally configuring a correspondence between a packet feature and application identifier information; and

the acquiring application identifier information corresponding to the to-be-parsed packet is specifically:

acquiring a packet feature of the to-be-parsed packet according to a parsing result acquired by parsing the to-be-parsed packet; and

searching, according to the configured correspondence between a packet feature and application identifier information, for the application identifier information corresponding to the packet feature.

According to one aspect, an embodiment of the present invention provides a packet service control apparatus, including:

a sending unit, configured to send a packet parse request that includes a to-be-parsed packet to a DPI serving network element, so that the DPI serving network element performs deep packet inspection on the to-be-parsed packet, and acquires application identifier information corresponding to the to-be-parsed packet;

a receiving unit, configured to receive a packet parse response message that includes the application identifier information and is sent by the DPI serving network element, and send the obtained application identifier information to the searching unit;

the searching unit, configured to acquire application identifier information from the receiving unit, search for a service control policy corresponding to the application identifier information, and send the service control policy obtained by searching to the control unit; and

the control unit, configured to acquire the service control policy from the searching unit, and perform service control on the packet according to the service control policy.

According to one aspect, an embodiment of the present invention provides a packet parsing apparatus, where the apparatus includes:

a receiving unit, configured to receive a packet parse request that includes a to-be-parsed packet and is sent by a DPI requesting network element, acquire the to-be-parsed packet from the packet parse request, and send the to-be-parsed packet to a parsing unit;

the parsing unit, configured to receive the to-be-parsed packet from the receiving unit, parse the to-be-parsed packet, acquire application identifier information corresponding to the to-be-parsed packet, and send the acquired application identifier information to a sending unit; and the sending unit, configured to acquire the application identifier information from the parsing unit, and send a packet parse response message that includes the application identifier information to the DPI requesting network element, so that the DPI requesting network element searches for a service control policy corresponding to the application identifier information.

In the packet control method provided by the embodiments of the present invention, a DPI requesting network element sends a packet parse request that includes a to-be-parsed packet to a DPI serving network element; the DPI serving network element performs deep packet inspection on the to-be-parsed packet, and acquires application identifier information; the DPI requesting network element receives a packet parse response message that includes the application identifier information and is sent by the DPI serving network element, searches for a service control policy corresponding to the application identifier information, and performs service control on the packet according to the service control policy. By using the foregoing technical solution, the DPI requesting network element does not need to learn specific application information in the to-be-parsed packet, and only needs to know an application identifier related to the to-be-parsed packet, which implements that an application layer feature is transparent for the DPI requesting network element. In a case in which an application layer protocol is changed, an application layer keyword matching logic of the DPI requesting network element does not need to be changed, so that implementation complexity of the DPI requesting network element is reduced.

### BRIEF DESCRIPTION OF DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of implementing service control based on a DPI function in the prior art;

FIG. 2 is a flowchart of an embodiment of a packet control method according to an embodiment of the present invention;

FIG. 3 is a flowchart of an embodiment of a packet parsing method according to an embodiment of the present invention;

FIG. 4 is an interaction status diagram of an embodiment of a packet control method according to an embodiment of the present invention;

FIG. 5 is an interaction status diagram of another embodiment of a packet control method according to an embodiment of the present invention;

FIG. 6 is an interaction status diagram of another embodiment of a packet control method according to an embodiment of the present invention;

FIG. 7 is an interaction status diagram of another embodiment of a packet control method according to an embodiment of the present invention;

FIG. 8 is an interaction status diagram of another embodiment of a packet control method according to an embodiment of the present invention;

FIG. 9 is an interaction status diagram of another embodiment of a packet control method according to an embodiment of the present invention;

FIG. 10 is an interaction status diagram of another embodiment of a packet control method according to an embodiment of the present invention;

FIG. 11 is an interaction status diagram of another embodiment of a packet control method according to an embodiment of the present invention;

FIG. 12 is an interaction status diagram of another embodiment of a packet control method according to an embodiment of the present invention;

FIG. 13 is an interaction status diagram of another embodiment of a packet control method according to an embodiment of the present invention;

FIG. 14 is an interaction status diagram of another embodiment of a packet control method according to an embodiment of the present invention;

FIG. 15 is an interaction status diagram of another embodiment of a packet control method according to an embodiment of the present invention;

FIG. 16 is an interaction status diagram of another embodiment of a packet control method according to an embodiment of the present invention;

FIG. 17 is a structural diagram of an embodiment of a packet service control apparatus according to an embodiment of the present invention; and

FIG. 18 is a structural diagram of an embodiment of a packet parsing apparatus according to an embodiment of the present invention.

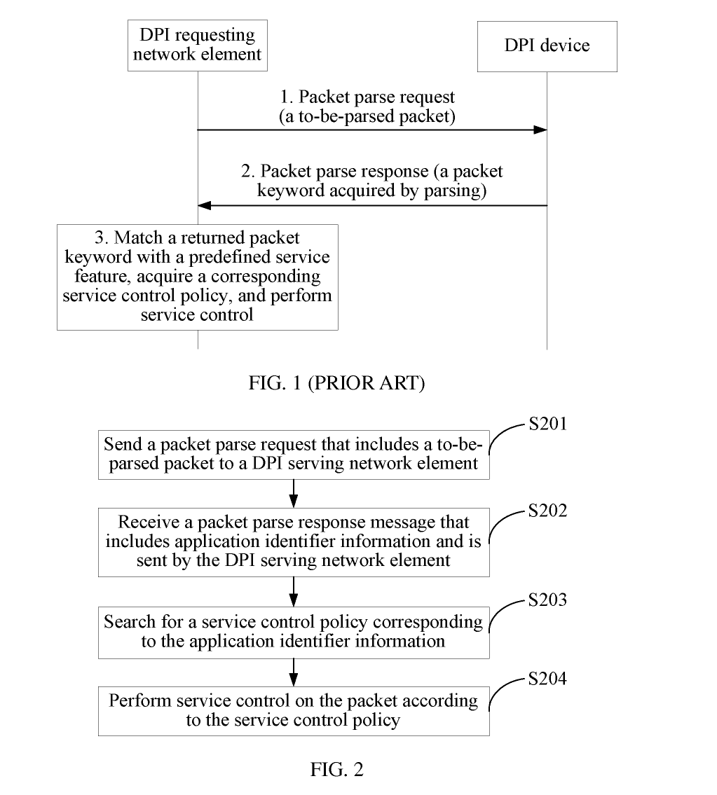

### DESCRIPTION OF EMBODIMENTS

On a bearer network of a telecommunications operator, various applications are carried at an upper layer of the TCP/IP protocol, and the operator cannot sense these applications directly, thereby causing problems, for example, a service is difficult to manage, content charging cannot be implemented, and information security requirement cannot be met. To solve these problems, a DPI technology is introduced to a telecommunications network to increase a capability of the network to sense packet application information. The operator has deployed devices on a large scale in the network to perform deep inspection, for example, performing application layer analysis on a packet or performing detection based on a traffic feature, so as to identify an application layer service type corresponding to the packet and/or extract key application-layer information from the packet for subsequent service processing.

In the prior art, a parsing result returned by a DPI device is closely related to a specific application type. Using the HTTP protocol as an example, after splitting the packet according to a definition of the protocol, the DPI device returns information, such as an HTTP method name, a version number, a URL, a Host header field, a User agent header field, and MIME content to a DPI requesting network element, so that the DPI requesting network element performs keyword matching, searches for a corresponding control policy according to a keyword, and performs service control, for example, charging, lawful interception, and QOS control.

However, because upgrade of the application layer protocol is changed, a packet parsing interface is directly affected by each application protocol. If a capability of parsing a new application type is added for the DPI device, a corresponding interface also needs to be defined, so that the interface definition is complex and is difficult to maintain stable. In addition, because the DPI requesting network element is responsible for determining a service type according to a keyword, when upgrade of the application layer protocol is changed, the DPI requesting network element always needs to modify a corresponding application layer keyword matching logic. This makes the implementation of the DPI requesting network element complex.

Therefore, the core idea of the embodiments of the present invention is to provide a packet control method to map a DPI parsing result to an application identifier. The DPI requesting network element acquires a service control policy according to application identifier information, so that the DPI requesting network element acquires a service control policy in a case in which specific application content of the packet does not need to be sensed. Therefore, complexity of an application layer corresponding to the DPI is transferred from a forwarding plane network element to a control plane network element, such as an external DPI and a policy entity. Under a premise that DPI-based service control is implemented, it is implemented that an application layer feature is transparent for the DPI requesting network element, so that the implementation of the DPI requesting network element is simplified.

The following further describes the technical solutions of the present invention in detail by using the accompanying drawings and embodiments.

FIG. 2 is a flowchart of an embodiment of a packet control method according to an embodiment of the present invention. It can be seen from FIG. 2 that the method includes:

Step S201: Send a packet parse request that includes a to-be-parsed packet to a deep packet inspection DPI serving network element, so that the deep packet inspection DPI serving network element performs deep packet inspection on the to-be-parsed packet and acquires application identifier information corresponding to the to-be-parsed packet.

Specifically, the method is executed by a DPI requesting network element, for example, a network element that needs to acquire a DPI identification and parsing result of the packet, which is specifically manifested as: a router, a digital subscriber line access multiplexer DSLAM, a broadband remote access server (BRAS), a gateway, or the like on a fixed-line network; a node NodeB, an evolved node eNodeB, a serving GPRS support node (SGSN), a gateway GPRS support node (GGSN), a serving gateway (S-GW), and a packet data gateway (PDN-GW) on a 3GPP network; an access point (AP), an access controller (AC), or the like on a WLAN network; and a packet data serving node (PDSN), an access service network gateway (ASN-GW), or the like on a non-3GPP network.

After receiving a service packet, the foregoing DPI requesting network element sends a packet parse request to the DPI serving network element, where the packet parse request includes a to-be-parsed packet. Specifically, the to-be-parsed packet may be manifested as a complete packet or only a packet identifier of the to-be-parsed packet. The DPI serving network element performs DPI parsing on the to-be-parsed packet or the packet identifier of the to-be-parsed packet, and acquires an application identifier corresponding to the to-be-parsed packet. Then, the DPI serving network element feeds back the application identifier information to the DPI requesting network element.

Step S202: Receive a packet parse response message that includes the application identifier information and is sent by the DPI serving network element.

Specifically, the DPI requesting network element receives the packet parse response message sent by the DPI serving network element, where the packet parse response message includes the application identifier corresponding to the to-be-parsed packet.

Step S203: Search for a service control policy corresponding to the application identifier information.

Specifically, after acquiring the application identifier corresponding to the to-be-parsed packet from the packet parse response message, the DPI requesting network element searches for a service control policy corresponding to the application identifier.

The method for searching for the service control policy corresponding to the application identifier may be implemented in various manners. For example, the DPI requesting network element interacts with a policy control network element; the policy control network element provides a service control policy, and sends the service control policy to the DPI requesting network element; or, a correspondence between an application identifier and a service control policy is preconfigured on the DPI requesting network element, and the DPI requesting network element searches locally to acquire a service control policy.

Step S204: Perform service control on the packet according to the service control policy.

Specifically, after acquiring the service control policy corresponding to the application identifier of the to-be-parsed packet, the DPI requesting network element performs service control on the packet, for example, charging, lawful interception, QOS control, gating, priority control, redirection, and packet enhancement.

By using the foregoing embodiment, during a service control operation, a DPI requesting network element does not need to focus on specific application content of a packet, for example, an HTTP method name, a version number, and a uniform resource locator URL in the HTTP protocol, but focuses only on a specific application identifier of the packet and acquires a service control policy according to the application identifier, which can reduce complexity of the DPI requesting network element.

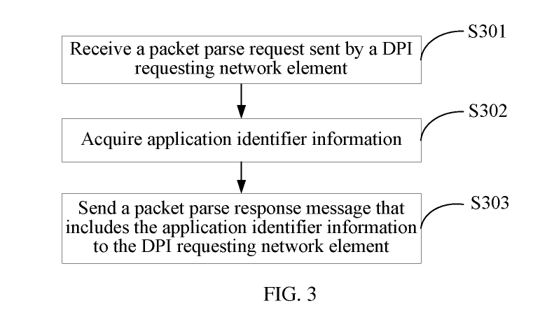

FIG. 3 is a flowchart of an embodiment of a packet parsing method according to an embodiment of the present invention. It can be seen from the figure that the packet parsing method includes:

Step S301: Receive a packet parse request that includes a to-be-parsed packet and is sent by a DPI requesting network element.

Specifically, the packet is parsed by a DPI serving network element, that is, a network element that can provide a packet identification and parsing capability on a network. The DPI serving network element may be an independent DPI server, or may be a DPI network formed by a plurality of DPI devices.

The DPI serving network element receives, through a network, the packet parse request sent by the DPI requesting network element, and acquires the to-be-parsed packet or a packet identifier of the to-be-parsed packet from the packet parse request.

Step S302: Parse the to-be-parsed packet, and acquire application identifier information corresponding to the to-be-parsed packet.

Specifically, the DPI serving network element parses the to-be-parsed packet, acquires a parsing result, for example, acquires a specific application, a packet type, a packet keyword, a packet length feature, or the like in the packet, and acquires, according to the parsing result, an application identifier corresponding to the to-be-parsed packet.

For a specific method for acquiring the application identifier, a correspondence between an application identifier and a specific application may be configured on the DPI serving network element; or, corresponding application identifier information may be acquired in a manner of interacting with an application identifier control gateway.

Step S303: Send a packet parse response message that includes the application identifier information to the DPI requesting network element, so that the DPI requesting network element searches for a service control policy corresponding to the application identifier information.

Specifically, after acquiring the application identifier, the DPI serving network element sends the application identifier to the DPI requesting network element by using the packet parse response message; and the DPI requesting network element acquires the service control policy, and performs service control on a network packet.

It can be found from the foregoing embodiment that a process of performing DPI inspection on a packet is performed by a DPI serving network element. After performing the DPI inspection, the DPI serving network element acquires an application identifier of the packet and sends the application identifier to a DPI requesting network element, so that the DPI requesting network element focuses only on the application identifier of the packet, and does not need to focus on a specific application of the packet. When a packet protocol is changed, modification does not need to be made. Therefore, implementation of the DPI requesting network element is simpler.

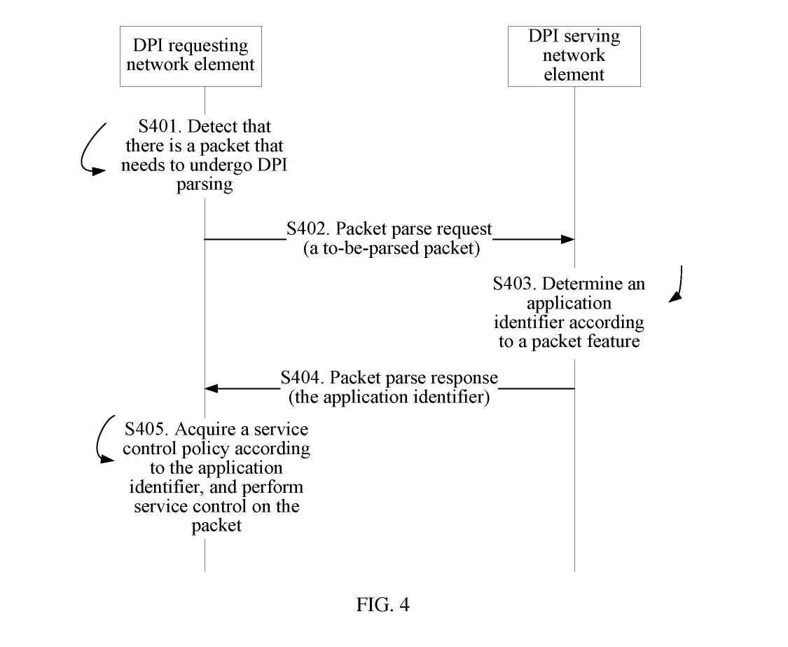

FIG. 4 is an interaction status diagram of a packet control method by using the packet parsing method in the foregoing embodiment. The packet control method specifically includes:

S401. A DPI requesting network element detects a packet, and checks whether there is a packet that needs to undergo DPI parsing.

S402. After detecting that there is a packet that needs to undergo DPI parsing, the DPI requesting network element sends a packet parse request to a DPI serving network element.

Specifically, the packet parse request may include a to-be-parsed packet or a packet identifier that is of a to-be-parsed packet and is used to represent the to-be-parsed packet.

S403. The DPI serving network element acquires an application identifier.

Specifically, after receiving the packet parse request, the DPI serving network element performs DPI inspection on the to-be-parsed packet or the packet identifier of the to-be-parsed packet, so as to acquire a packet feature, for example, acquires specific application content such as a protocol type of the packet, a packet keyword, and a packet length feature.

Then, the DPI serving network element locally searches for a corresponding application identifier according to the packet feature, or in a case in which a correspondence between a packet feature and an application identifier is not configured locally, the DPI serving network element interacts with a control gateway that has a corresponding application identifier searching function, and acquires an application identifier corresponding to the to-be-parsed packet.

S404. The DPI serving network element sends a packet parse response to the DPI requesting network element.

Specifically, after acquiring the application identifier in the foregoing manner, the DPI serving network element sends, by using the packet parse response message, the acquired application identifier to the DPI requesting network element, so that the DPI requesting network element uses the application identifier.

S405. The DPI requesting network element acquires the application identifier according to the received packet parse response message, searches for a desired service control policy according to the application identifier, and performs service control on the packet according to the service control policy obtained by searching.

Specifically, the DPI requesting network element may acquire the service control policy according to the application identifier in a plurality of manners. For example, the DPI requesting network element locally configures a correspondence between an application identifier and a service control policy, or the DPI requesting network element does not configure a correspondence between an application identifier and a service control policy locally, but interacts with a policy control gateway to acquire a service control policy. Then, the DPI requesting network element performs service control, for example, charging and interception, according to the acquired service control policy.

By using the foregoing embodiment, during a service control operation, a DPI requesting network element does not need to focus on specific application content of the packet, for example, an HTTP method name, a version number, and a uniform resource locator URL in the HTTP protocol, but focuses only on a specific application identifier of the packet and acquires a service control policy according to the application identifier, which can reduce complexity of the DPI requesting network element.

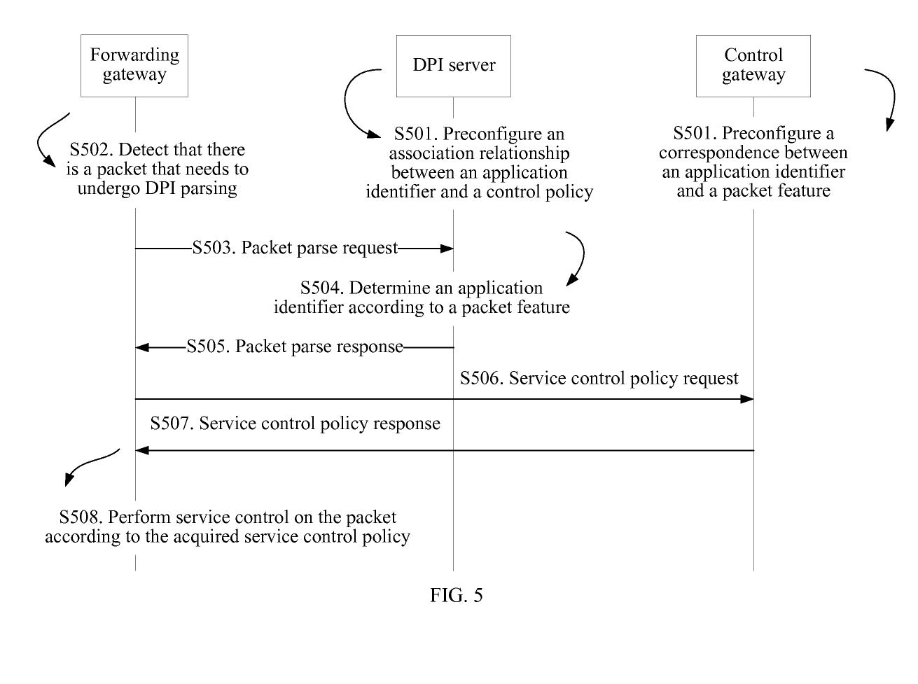

FIG. 5 is an interaction status diagram of another embodiment of a packet control method according to the present invention.

In this embodiment, that a DPI requesting network element is a forwarding gateway, a DPI requesting network element is a DPI server, and a policy control network element is a control gateway is used as an example. A correspondence between an application identifier and a packet feature is configured on the DPI server, and a correspondence between an application identifier and a service control policy is configured on the control gateway. It can be seen from the figure that the method includes:

Step S501: Preconfigure a correspondence between a packet feature and an application identifier on a DPI server, and preconfigure a correspondence between an application identifier and a service control policy on a control gateway.

Specifically, the foregoing preconfiguration may be implemented by a network management system, or may be implemented by a network open interface or another management network element, which is not limited in the embodiment of the present invention.

Step S502: A forwarding gateway detects that there is a packet that needs to undergo DPI parsing and needs to undergo service control according to a parsing result.

Step S503: The forwarding gateway sends a to-be-parsed packet to the DPI server by using a packet parse request.

Step S504: The DPI server parses the to-be-parsed packet.

Specifically, the DPI server acquires a packet feature such as a protocol type and/or a packet keyword by using a method such as packet protocol identification and parsing. The DPI server determines, according to the foregoing packet feature and the preconfigured correspondence between a packet feature and an application identifier, an application identifier corresponding to the packet.

For example, the DPI server determines, according to a URL “www.foo.com” of an HTTP packet, that an application identifier of the HTTP packet is 1001.

Step S505: The DPI server sends an application identifier to the forwarding gateway by using a packet parse response message.

Step S506: The forwarding gateway requests a service control policy from the control gateway by using a service control policy request message.

Specifically, after acquiring the application identifier, the forwarding gateway sends the service policy request message to the control gateway, where the message includes the application identifier.

Step S507: The control gateway acquires corresponding service control policy information according to the application identifier, and sends the policy information to the forwarding gateway by using a service control policy response message.

Step S508: The forwarding gateway performs service control on the packet according to the acquired service control policy.

In the foregoing embodiment, a DPI server locally configures a correspondence between an application identifier and a packet feature; a forwarding gateway does not configure a correspondence between an application identifier and a service control policy, but interacts with a control gateway to acquire a service control policy.

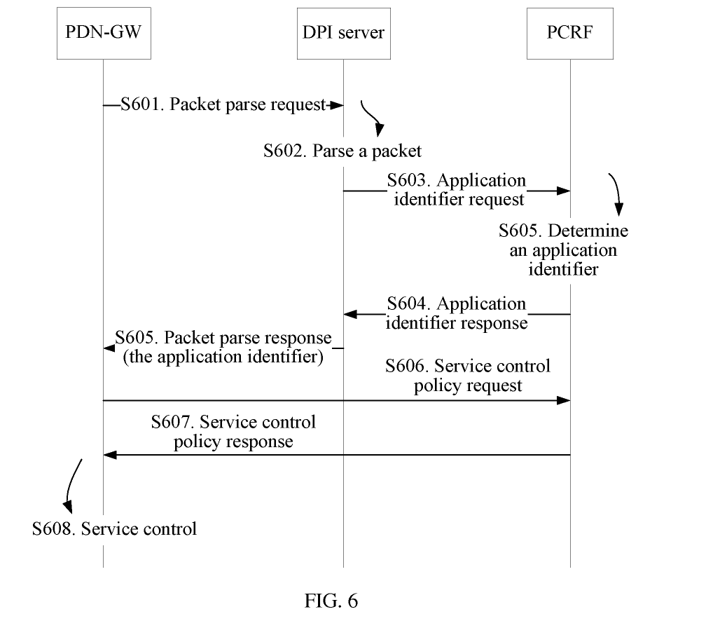

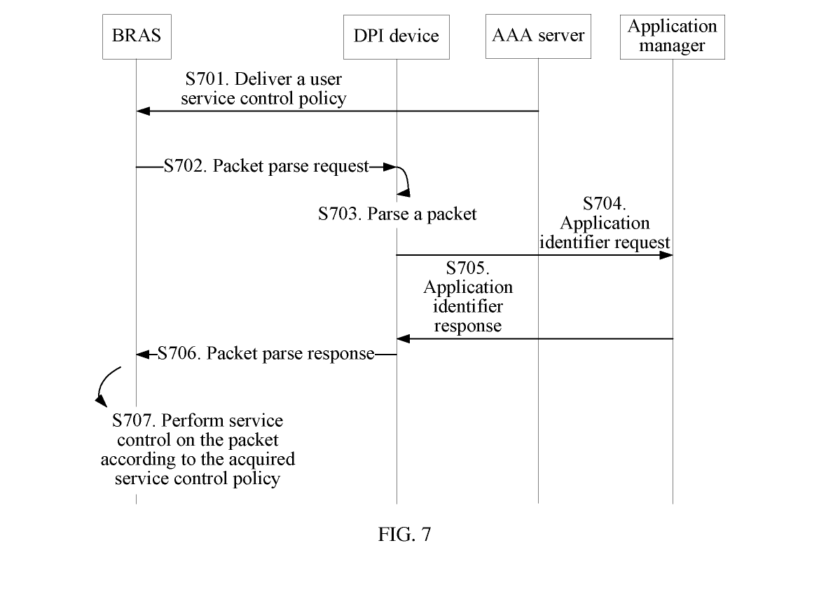

FIG. 6 is an interaction status diagram of a packet control method according to still another embodiment of the present invention. In this embodiment, a DPI requesting device is a PDN-GW on a 3GPP EPS network, a DPI serving network element is a DPI server, and both an application identifier control network element and a policy control network element are a PCRF.

It can be seen from the figure that the packet control method includes:

S601. A PDN-GW sends a to-be-parsed packet to a DPI server by using a packet parse request.

S602. The DPI server acquires a packet feature such as a protocol type and/or a packet keyword by using a method such as packet protocol identification and parsing.

S603. The DPI server sends an application identifier request message to a PCRF, where the application identifier request message includes the foregoing packet feature information.

S604. The PCRF determines an application identifier of the packet according to packet feature information and an association relationship between a packet feature and an application identifier.

For example, the PCRF determines, according to that a service type of a packet is a P2P service, that the application identifier of the packet is 1002. The PCRF sends the application identifier to the DPI server by using an application identifier response message.

S605. The DPI server sends a packet parse response to the PDN-GW.

Specifically, the DPI server sends the acquired application identifier to the PDN-GW by using a packet parse response message.

S606. The PDN-GW sends a service control policy request message.

Specifically, the PDN-GW requests a service control policy from the PCRF by sending a service control policy request message, where the service control policy request message includes the application identifier.

S607: The PCRF acquires corresponding service control policy information according to the application identifier, and sends the policy information to the PDN-GW by using a service control policy response message.

Specifically, the PCRF locally searches for service control policy information corresponding to the application identifier, and sends a service control policy obtained by searching to the PDN-GW by using the service control policy response message.

Finally, in S608, the PDN-GW performs service control on the packet according to the acquired service control policy.

In the foregoing embodiment, a DPI server locally configures a correspondence between an application identifier and a packet feature; a forwarding gateway configures a correspondence between an application identifier and a service control policy, and the DPI server acquires a service control policy on the forwarding gateway.

FIG. 7 is an interaction status diagram of a packet control method according to yet another embodiment of the present invention. In this embodiment, a DPI requesting device is a BRAS, and a DPI serving network element is a DPI server. Service control policy information is delivered by an AAA server to the BRAS in advance, while the DPI server acquires an application identifier of the packet by interacting with an application manager. It can be seen from the figure that the packet control method includes:

S701. An AAA server delivers user service flow control policy information to a BRAS.

Specifically, when a user accesses a network, the AAA server delivers the service flow control policy information to the BRAS by using a RADIUS authentication response message, that is, the AAA server configures a correspondence between an application identifier and a service control policy on the BRAS.

S702. The BRAS sends a packet parse request to a DPI server.

Specifically, when the BRAS detects that there is a packet that needs to undergo deep identification and parsing to implement service control, the BRAS sends a to-be-parsed packet to a

DPI device by using the packet parse request.

S703. The DPI server sends a packet and parses the packet.

Specifically, the DPI server acquires a packet feature such as a protocol type and/or a packet keyword by using a method such as packet protocol identification and parsing.

S704. The DPI server sends an application identifier request message to an application manager.

Specifically, after acquiring the packet feature of the packet by means of deep packet parsing, the DPI server sends the application identifier request message to the application manager, where the application identifier request message includes the foregoing packet feature information, such as an application protocol type.

S705. The application manager sends an application identifier to the DPI device by using an application identifier response message.

Specifically, the application manager determines an application identifier of the packet according to the packet feature information, and sends the application identifier to the DPI device by using the application identifier response message.

S706. The DPI device sends the application identifier to the BRAS by using a packet parse response message.

S707. The BRAS performs service control on the packet according to the acquired application identifier and a user service flow control policy.

Specifically, because the AAA server configures the correspondence between an application identifier and a service control policy on the BRAS in step S701, after acquiring the application identifier, the BRAS locally searches for a corresponding service control policy, and performs control on a packet service according to the service control policy.

In this embodiment, a correspondence between an application identifier and a service control policy is configured on a BRAS end, and a DPI server does not configure a correspondence between an application identifier and a packet feature, but acquires an application identifier by interacting with the application manager.

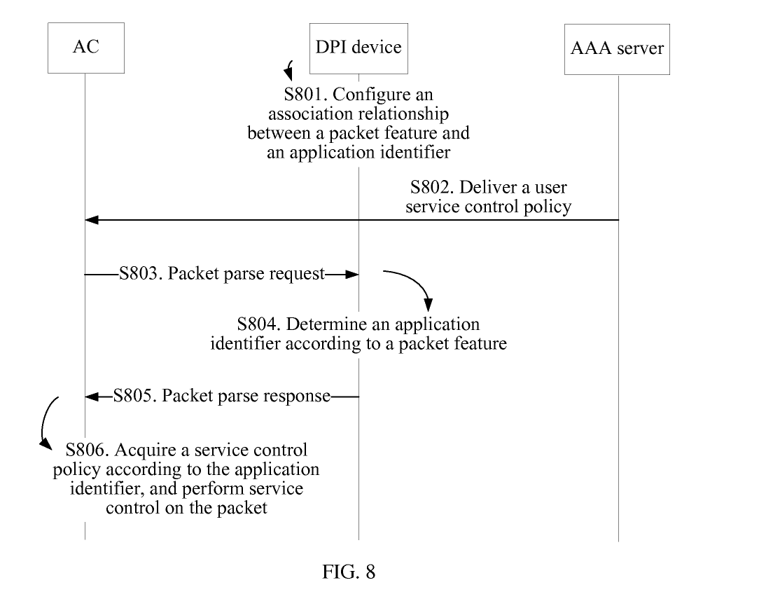

FIG. 8 is an interaction status diagram of a packet control method according to yet another embodiment of the present invention. In this embodiment, a DPI requesting device is an AC on a WLAN, and a DPI serving network element is a DPI server. Service control policy information is delivered by an AAA server to a BRAS in advance, and a correspondence between a packet feature and an application identifier is preconfigured on the DPI server. It can be seen from the figure that the packet control method includes:

S801. Preconfigure an association relationship between a packet feature and an application identifier on a DPI device.

Specifically, the foregoing preconfiguration may be implemented by a network management system, or may be implemented by a network open interface or another management network element, which is not limited in the present invention.

S802. Configure a correspondence between an application identifier and a control policy on an AC.

Specifically, when a user accesses a network, the AAA server delivers user service flow policy information to the AC by using a RADIUS authentication response message, where the user service flow policy information includes a correspondence between an application identifier and a control policy.

S803: The AC sends a to-be-parsed packet to the DPI device by using a packet parse request.

S804. The DPI server parses the packet.

Specifically, the DPI server acquires a packet feature such as a protocol type and/or a packet keyword by using a method such as packet protocol identification and parsing, and determines an application identifier corresponding to the packet according to the foregoing packet feature and the preconfigured association relationship between a packet feature and an application identifier.

S805. The DPI device sends an application identifier to the AC by using a packet parse response message.

S806. The AC acquires a corresponding user service flow control policy according to the application identifier, and performs service control on the packet according to the policy.

In this embodiment, a correspondence between a packet feature and an application identifier is configured on a DPI server, and a correspondence between a service control policy and an application identifier is configured on an AC; both the DPI server and the AC acquire an application identifier and a service control policy, with no need to interact with a control gateway.

Definitely, the foregoing several embodiments are used as examples for description. In a specific application, the several embodiments may also be combined.

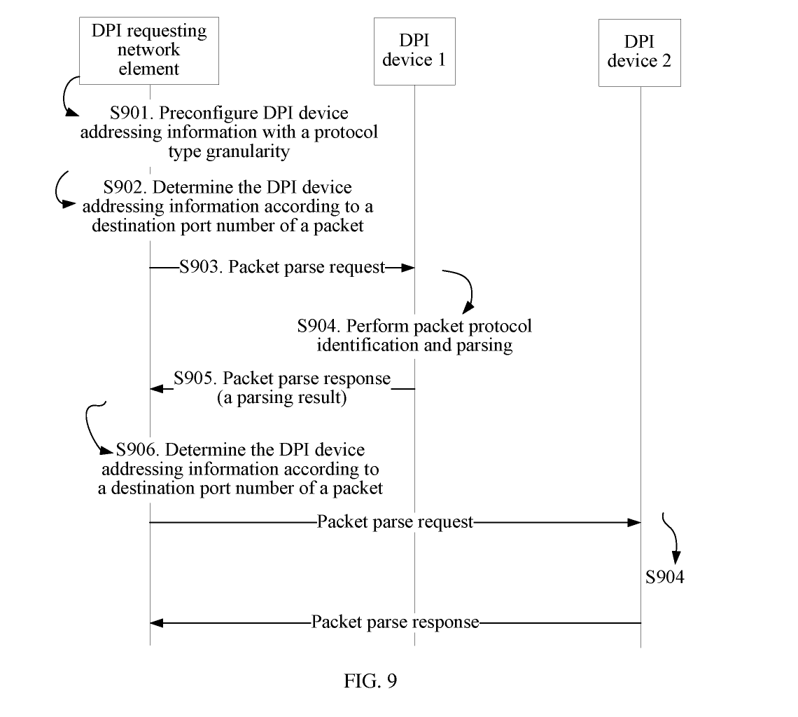

FIG. 9 is an interaction status diagram of a packet control method according to yet another embodiment of the present invention. In this embodiment, a DPI serving network element is two DPI devices, namely, a DPI device 1 and a DPI device 2.

DPI device addressing information uses a protocol type as a granularity, and is preconfigured on a DPI requesting network element. A DPI context identifier is represented by an IP quintuple.

Referring to FIG. 9, the packet control method includes:

S901. Preconfigure, on a DPI requesting network element, DPI device addressing information with a protocol type granularity.

Specifically, for example, the HTTP protocol corresponds to an IP address of the DPI device 1, and the P2P protocol corresponds to an IP address of the DPI device 2.

S902. The DPI requesting network element determines the DPI device addressing information according to a destination port number of a to-be-parsed packet.

Specifically, for example, if the destination port number of the to-be-parsed packet is 80, the DPI requesting network element determines that the DPI device 1 parses the packet.

S903. The DPI requesting network element sends the to-be-parsed packet to a DPI device 1 by using a packet parse request.

S904. The DPI device 1 performs protocol identification or parsing on the packet.

Specifically, the DPI device 1 obtained by addressing identifies or parses the to-be-parsed packet when necessary, and when necessary, the DPI device 1 further searches, according to an IP quintuple of the packet, for a DPI context corresponding to a service flow to which the packet belongs. If acquiring the DPI context successfully, the DPI device 1 identifies and parses the packet according to the DPI context and the to-be-parsed packet.

S905. The DPI device 1 returns an identification or parsing result to the DPI requesting network element by using a packet parse response message, so that the DPI requesting network element performs service control according to the identification or parsing result.

Then, the DPI requesting network element determines the DPI device addressing information according to the destination port number of the to-be-parsed packet; if the destination port number of the packet is 6881, the DPI requesting network element determines that the DPI device 2 parses the packet. Then, step S902 to step S905 are repeated, which is not repeatedly described.

In this embodiment, that DPI device addressing information uses a protocol type as a granularity is used as an example. In addition, this embodiment is also applicable to DPI device addressing information with another granularity, such as a device granularity or a user granularity, of which an implementation process is basically the same as the process in this embodiment, which is not repeatedly described.

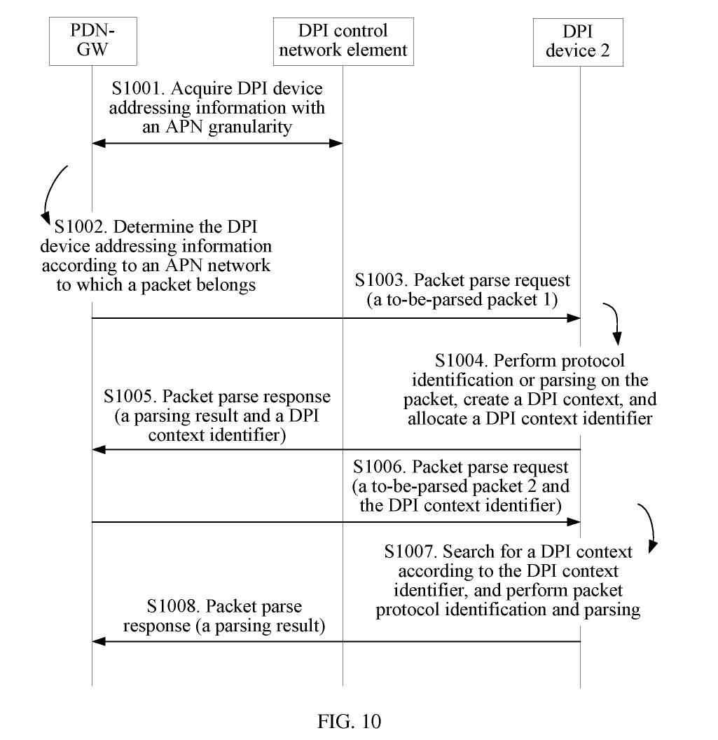

FIG. 10 is an interaction status diagram of a packet control method according to yet another embodiment of the present invention. In this embodiment, a DPI requesting network element is a PDN-GW. DPI device addressing information uses an APN as a granularity, and is acquired by interacting with a DPI control network element; and a DPI context identifier is allocated by a DPI device.

Referring to FIG. 10, the packet control method includes:

S1001. A PDN-GW acquires, from a DPI control network element, DPI device addressing information with an APN granularity.

Specifically, for example, a user packet on an APN1 network corresponds to an IP address of a DPI device 1, and a user packet on an APN2 network corresponds to an IP address of a DPI device 2.

S1002. The PDN-GW determines the DPI device addressing information according to an APN network to which a to-be-parsed packet belongs.

Specifically, for example, if a to-be-parsed packet 1 is a packet on the APN2 network, the PDN-GW determines that the DPI device 2 parses the packet.

S1003: The PDN-GW sends the to-be-parsed packet 1 to a DPI device 2 by using a packet parse request.

Specifically, if the to-be-parsed packet 1 is a packet on the APN2 network, the PDN-GW determines that the DPI device 2 parses the packet. Therefore, the PDN-GW sends the to-be-parsed packet 1 to the DPI device 2. However, because a packet of the service flow is parsed for the first time, a DPI context identifier is not included in the request message.

S1004. The DPI device 2 performs protocol identification or parsing on the packet.

Specifically, the DPI device 2 may further create a DPI context corresponding to the service flow, and allocate a DPI context identifier.

S1005. The DPI device 2 sends a packet parse response message to the PDN-GW.

Specifically, the DPI device 2 returns an identification or parsing result and the allocated DPI context identifier to the PDN-GW by using the packet parse response message, so that the PDN-GW performs service control according to the identification or parsing result.

When necessary, the packet parse response message may continues report indication, so as to indicate that subsequent packets of the service flow still need to be reported to the DPI continuously.

S1006. When a to-be-parsed packet 2 of a service flow reaches the PDN-GW, the PDN-GW sends the to-be-parsed packet 2 to the DPI device 2 by using a packet parse request, and also includes, in the request message, the DPI context identifier returned in S1005.

S1007. The DPI device 2 acquires, according to the DPI context identifier in the request message, a DPI context corresponding to the service flow, and performs protocol identification and parsing based on the DPI context and the to-be-parsed packet 2.

S1008. The DPI device 2 returns an identification or parsing result to the PDN-GW by using a packet parse response message, where the packet parse response message optionally includes the allocated DPI context identifier and/or a continue report indication.

In this embodiment, the DPI requesting network element is a PDN-GW on a 3GPP EPS network. However, this embodiment is also applicable to a DPI requesting network element, such as a GGSN, an SGSN, an S-GW, an AP, an AC, a BRAS, a PDSN, or an ASN-GW, on another mobile network or fixed-line network, of which an implementation process is basically the same as the process in this embodiment, which is not repeatedly described.

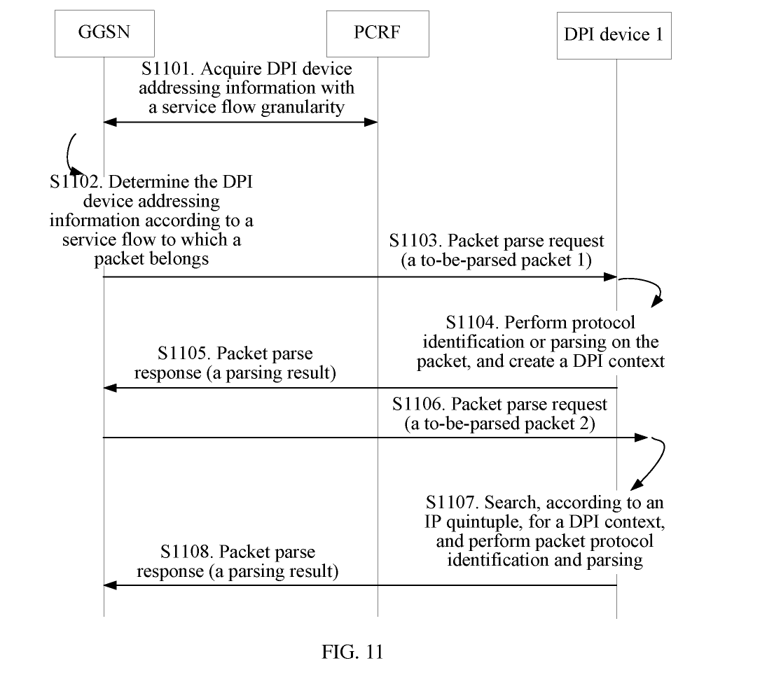

FIG. 11 is an interaction status diagram of a packet control method according to yet another embodiment of the present invention. In this embodiment, a DPI requesting network element is a GGSN on a 3GPP UMTS network. DPI device addressing information uses a service flow as a granularity, and is acquired by interaction with a PCRF; and a DPI context is identified by using an IP quintuple.

Referring to FIG. 11, the method includes:

S1101. A GGSN acquires, from a PCRF, DPI device addressing information with a service flow granularity.

Specifically, for example, a user packet of a service flow 1 corresponds to an IP address of a DPI device 1, and a user packet of a service flow 2 corresponds to an IP address of a DPI device 2. Optionally, the acquiring process may be implemented by using a process of delivering a PCC policy, and the service flow may be identified by using an IP quintuple, or a group of IP quintuples, or multiple groups of IP quintuples.

S1102. The GGSN determines the DPI device addressing information according to a service flow to which a to-be-parsed packet 1 belongs.

Specifically, for example, if a to-be-parsed packet is a packet in the service flow 1, the GGSN determines that the DPI device 1 parses the packet.

S1103: The GGSN sends the to-be-parsed packet 1 to the DPI device 1 by using a packet parse request.

S1104. The DPI device 1 performs protocol identification or parsing on the packet.

Specifically, for example, the DPI device 1 searches for a corresponding DPI context according to an IP quintuple of the packet. Because the service flow is parsed for the first time, the DPI context does not exist. After the search fails, the DPI device 1 creates a DPI context corresponding to the service flow, where the DPI context is identified by using the IP quintuple.

S1105. The DPI device 1 returns an identification or parsing result to the GGSN by using a packet parse response message.

Specifically, the packet parse response message optionally further includes a continue report indication, so as to indicate that subsequent packets of the service flow still need to be reported to the DPI continuously.

S1106. When a to-be-parsed packet 2 of the service flow reaches the GGSN, the GGSN sends the to-be-parsed packet 2 to the DPI device 1 by using a packet parse request.

S1107. The DPI device 1 searches, according to an IP quintuple of the to-be-parsed packet 2 in the request message, for a DPI context corresponding to the service flow, and performs protocol identification and parsing based on the DPI context and the to-be-parsed packet 2.

S1108. The DPI device 1 returns an identification or parsing result to the GGSN by using a packet parse response message, so that the GGSN performs service control according to the identification or parsing result.

In addition, the message may further include a continue report indication.

In this embodiment, the DPI requesting network element is a GGSN on a 3GPP UMTS network. This embodiment is also applicable to a DPI requesting network element, such as a PDN-GW, an AC, a BRAS, a PDSN, or an ASN-GW, on another mobile network or fixed-line network, of which an implementation process is basically the same as the process in this embodiment, which is not repeatedly described.

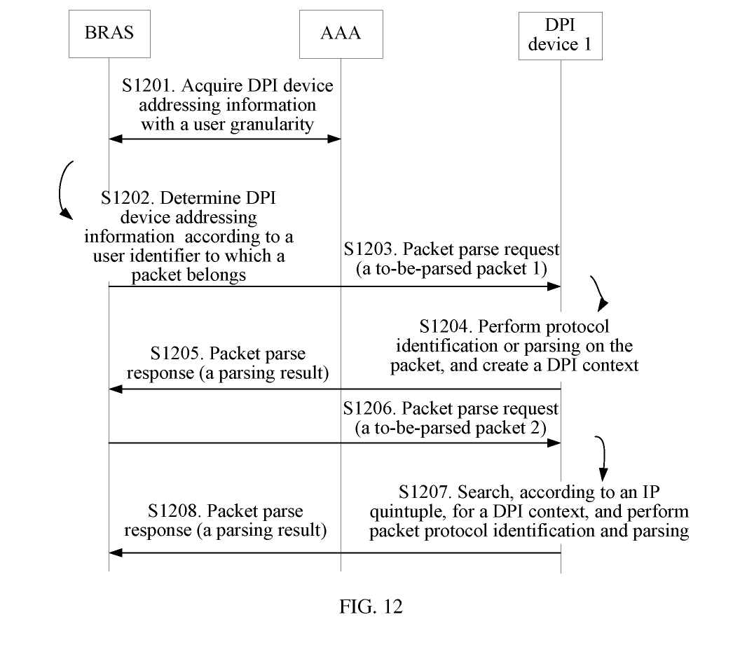

FIG. 12 is an interaction status diagram of a packet control method according to yet another embodiment of the present invention. In this embodiment, a DPI requesting network element is a BRAS on a fixed-line network. DPI device addressing information uses a user as a granularity, and is acquired by interaction with an AAA server; and a DPI context is identified by using an IPv6 Flow Label. The method includes:

S1201. A BRAS acquires, from an AAA, DPI device addressing information with a user granularity.

Specifically, for example, a packet of a user 1 corresponds to a device identifier of a DPI device 1, and a packet of a user 2 corresponds to a device identifier of a DPI device 2. Optionally, the acquiring process may be implemented by using a process of user network access authentication, and the user may be identified by using an IP address, a MAC address, a Line ID, or the like.

S1202. The BRAS determines the DPI device addressing information according to a user to which a to-be-parsed packet 1 belongs.

Specifically, for example, if the to-be-parsed packet is a packet of a user 1, the BRAS determines that a DPI device 1 parses the packet.

S1203: The BRAS sends a to-be-parsed IPv6 packet 1 to a DPI device 1 by using a packet parse request.

S1204. The DPI device 1 performs protocol identification or parsing on the packet.

Specifically, for example, the DPI device 1 searches for a corresponding DPI context according to the IPv6 Flow Label of the packet. Because the service flow is parsed for the first time, the DPI context does not exist. After the search fails, the DPI device 1 creates a DPI context corresponding to the service flow, where the DPI context is identified by using the IPv6 Flow Label.

S1205. The DPI device 1 returns an identification or parsing result to the BRAS by using a packet parse response message.

Specifically, for example, the packet parse response message further includes a continue report indication, so as to indicate that subsequent packets of the service flow still need to be reported to the DPI continuously.

S1206. When a to-be-parsed packet 2 of the service flow reaches the BRAS, the BRAS sends the to-be-parsed packet 2 to the DPI device 1 by using a packet parse request.

S1207. The DPI device 1 searches, according to an IPv6 Flow Label of the to-be-parsed packet 2 in the request message, for a DPI context corresponding to the service flow, and performs protocol identification and parsing based on the DPI context and the to-be-parsed packet 2.

S1208. The DPI device 1 returns an identification or parsing result to the BRAS by using a packet parse response message, so that the BRAS performs service control on the packet according to the identification or parsing result.

Specifically, the packet parse response message may further include a continue report indication.

In this embodiment, a DPI requesting network element is a BRAS on a fixed-line network. This embodiment is also applicable to a DPI requesting network element, such as a GGSN, an SGSN, an S-GW, a PDN-GW, an AC, an AP, a PDSN, or an ASN-GW, on another mobile network or fixed-line network, of which an implementation process is basically the same as the process in this embodiment, which is not repeatedly described.

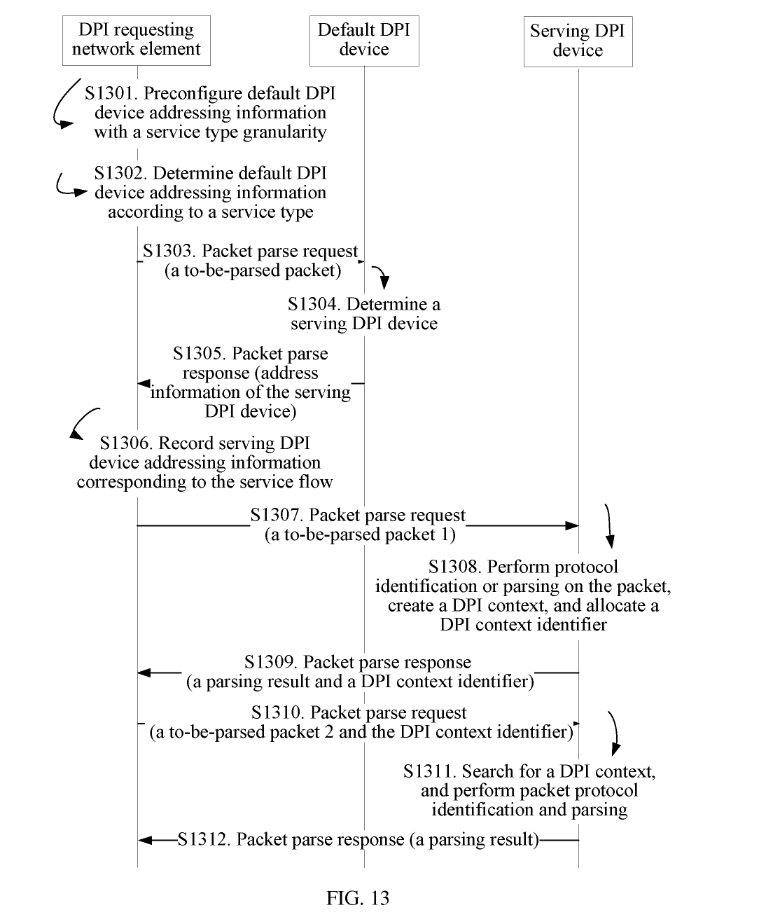

FIG. 13 is an interaction status diagram of a packet control method according to yet another embodiment of the present invention. In this embodiment, DPI device addressing information is acquired by interaction with a specific DPI device, and the method includes:

S1301. Preconfigure, on a DPI requesting network element, default DPI device addressing information with a service type granularity.

For example, a Web service corresponds to an IP address of a default DPI device, and a Video service corresponds to an IP address of a default DPI device 2. This embodiment uses the Web service as an example, and does not describe the default DPI device 2.

S1302. The DPI requesting network element determines default DPI device addressing information according to a service type of a to-be-parsed packet 1.

For example, if a destination port number of the packet is 80, the DPI requesting network element determines that the packet is a Web service, and further acquires an IP address of the default DPI device.

S1303. The DPI requesting network element sends a packet parse request to the default DPI device.

In this step, the packet parse request may further include a to-be-parsed packet or a packet identifier.

S1304. The default DPI device allocates a serving DPI device resource to the service flow.

S1305. The default DPI device returns a serving DPI device identifier to the DPI requesting network element by using a packet parse response message.

S1306. The DPI requesting network element records a serving DPI device identifier corresponding to the service flow.

S1307. The DPI requesting network element sends the to-be-parsed packet 1 to a serving DPI device by using a packet parse request.

S1308. The serving DPI device performs protocol identification or parsing on the packet.

Specifically, the serving DPI device creates a DPI context corresponding to the service flow, and allocates a DPI context identifier.

S1309. The serving DPI device returns an identification or parsing result and a DPI context identifier to the DPI requesting network element by using a packet parse response message.

In this step, the packet parse response message may further include a continue report indication, so as to indicate that subsequent packets of the service flow still needs to be reported to the DPI continuously.

S1310. When a to-be-parsed packet 2 of the service flow reaches the DPI requesting network element, the DPI requesting network element sends, according to a continue report indication, the to-be-parsed packet 2 and the DPI context identifier of the service flow to the serving DPI device by using a packet parse request.

S1311. The serving DPI device searches, according to the DPI context identifier in the request message, for a DPI context corresponding to the service flow, and performs protocol identification and parsing based on the DPI context and the to-be-parsed packet 2.

S1312. The serving DPI device returns an identification or parsing result to the DPI requesting network element by using a packet parse response message, where the packet parse response message optionally includes a continue report indication.

Then, the DPI requesting network element acquires a service control policy according to an application identifier in the parse response message, and performs service control on subsequent packets.

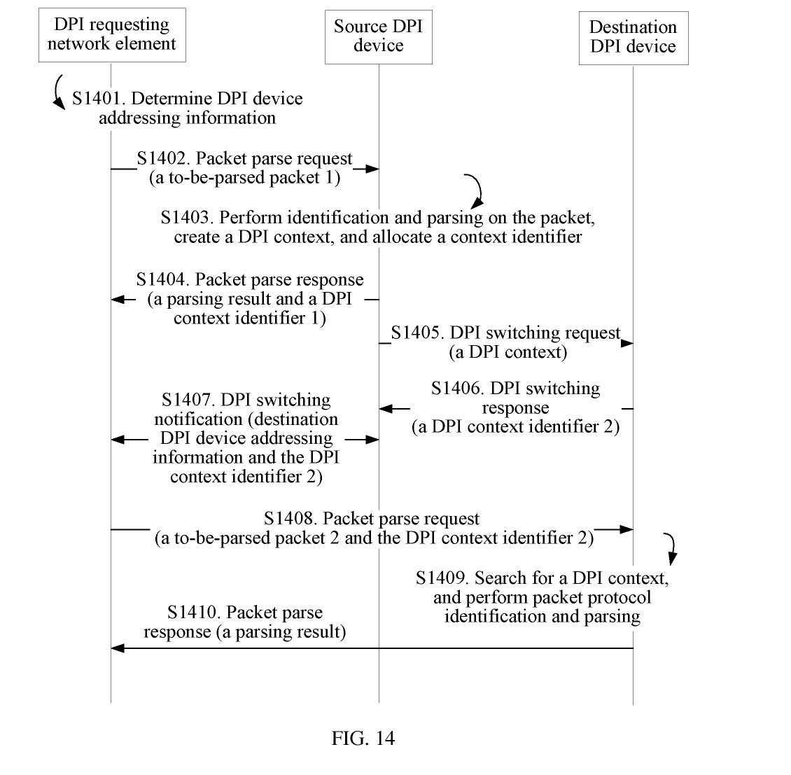

FIG. 14 is an interaction status diagram of a packet control method according to yet another embodiment of the present invention. In this embodiment, when a DPI device is switched, a source DPI device sends new DPI device addressing information and/or DPI context addressing information to a DPI requesting network element. The method includes:

S1401. A DPI requesting network element determines source DPI device addressing information according to a protocol type of a to-be-parsed packet 1.

Specifically, an association relationship between a protocol type and addressing information may be acquired in any manner of the foregoing embodiments.

S1402. The DPI requesting network element sends a packet parse request to a source DPI device, where the packet parse request includes the to-be-parsed packet 1.

S1403. The source DPI device performs protocol identification or parsing on the packet, creates a DPI context for the service flow, and allocates a DPI context identifier 1.

S1404. A default DPI device returns a parsing result and the DPI context identifier 1 to the DPI requesting network element by using a packet parse response message.

Specifically, processing of subsequent to-be-parsed packets of the service flow is the same as that in the foregoing embodiment, which is not repeatedly described.

S1405. Due to a reason such as load balancing or device maintenance, the source DPI device needs to switch a DPI function for subsequent packets of the service flow to a destination DPI device.

The source DPI device sends a DPI switching request to the destination DPI device, where the DPI switching request includes a DPI context of one or more service flows that are stored.

S1406. The destination DPI device stores the DPI context carried in the switching request message and returns a switching request response.

Optionally, the destination DPI device reallocates a context identifier 2 to the DPI context, and notifies the source DPI device by using a response message.

S1407. The source DPI device notifies the DPI requesting network element of destination DPI device addressing information by using a DPI switching notification message, where the DPI switching notification message optionally includes the DPI context identifier 2 allocated by the destination DPI device.

Another implementation manner of this step may be that the destination DPI device directly sends a switching notification message to the DPI requesting network element.

S1408. The DPI requesting network element stores the destination DPI device and the DPI context identifier 2.

Subsequently, when a to-be-parsed packet 2 of the service flow reaches the DPI requesting network element, the DPI requesting network element sends the to-be-parsed packet 2 and the DPI context identifier 2 of the service flow to the destination DPI device by using a packet parse request.

S1409. The destination DPI device searches, according to the DPI context identifier 2 in the request message, for a DPI context corresponding to the service flow, and performs protocol identification and parsing based on the DPI context and the to-be-parsed packet 2.

S1410. The destination DPI device returns an identification or parsing result to the DPI requesting network element by using a packet parse response message, where the packet parse response message optionally includes a continue report indication.

Then, the DPI requesting network element acquires a service control policy according to an application identifier in the parse response message, and performs service control on subsequent packets.

In this embodiment, the DPI device is used to allocate a DPI context identifier. If an self-own identifier of the packet, such as an IP quintuple or an IPv6 Flow Label, or a DSCP code, is used as the DPI context identifier, descriptions about allocation and pushing of a new DPI context identifier in the foregoing step 1406 and 1407 may be omitted.

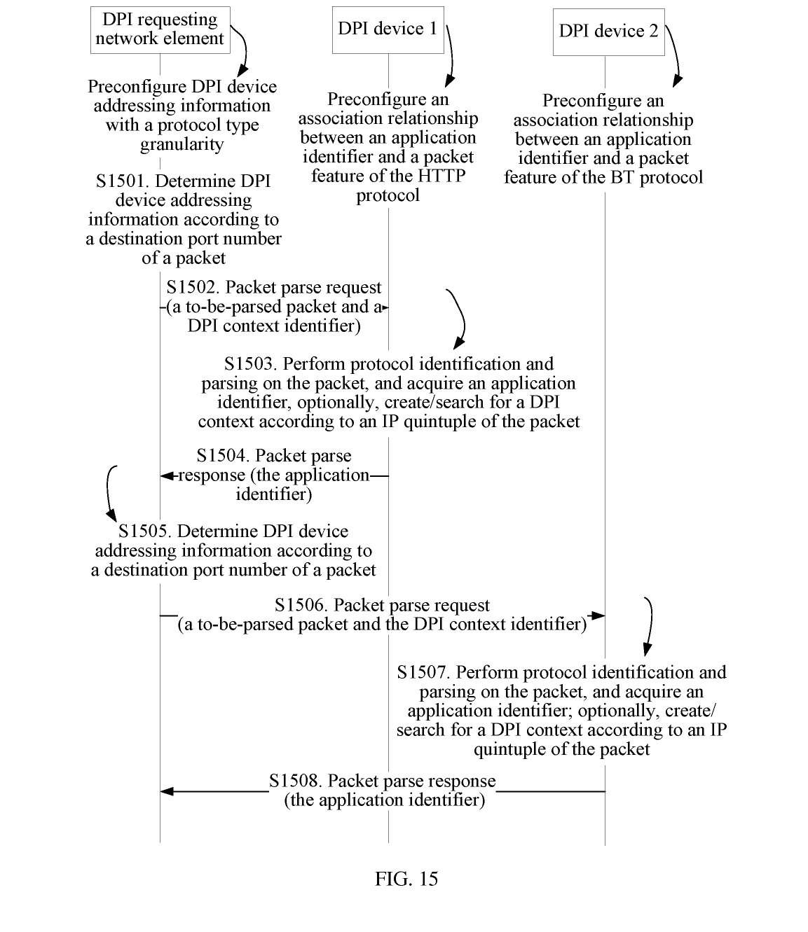

FIG. 15 is an interaction status diagram of a packet control method according to yet another embodiment of the present invention. In this embodiment, a DPI requesting network element preconfigures DPI device addressing information with a user group granularity and an association relationship between an application identifier and a service control policy; and a DPI device preconfigures an association relationship between a packet feature and an application identifier.

Referring to FIG. 15, the method includes:

S1501. Preconfigure, on a DPI requesting network element, DPI device addressing information with a protocol type granularity.

For example, the HTTP protocol corresponds to an IP address of a DPI device 1, and the BT protocol corresponds to an IP address of a DPI device 2; and an association relationship between a packet feature of a related protocol and an application identifier is preconfigured on a corresponding DPI device.

S1502. The DPI requesting network element determines the DPI device addressing information according to a destination port number of a to-be-parsed packet.

For example, if a destination port number of a packet is 80, the DPI requesting network element determines that the DPI device 1 parses the packet.

S1503. The DPI requesting network element sends the to-be-parsed packet to a DPI device 1 by using a packet parse request.

S1504. The DPI device 1 performs protocol identification or parsing on the packet.

Optionally, the DPI device 1 further searches, according to an IP quintuple of the packet, for a DPI context corresponding to a service flow to which the packet belongs; if acquiring the DPI context successfully, the DPI device 1 performs identification and parsing on the packet according to the DPI context and the to-be-parsed packet; and the DPI device 1 maps a packet identification and parsing result to a corresponding application identifier.

S1505. The DPI device 1 returns an application identifier to the DPI requesting network element by using a packet parse response message, so that the DPI requesting network element performs service control on the packet according to the application identifier.

S1506 to S1508. The DPI requesting network element determines the DPI device addressing information according to the destination port number of the to-be-parsed packet; if the destination port number of the packet is 6881-6889, the DPI requesting network element determines that a DPI device 2 parses the packet. The DPI device 2 returns a corresponding application identifier according to a parsing result. Step S1506 to step S1508 are similar to step S1503 to step S1505, and are not repeatedly described herein.

In this embodiment, that DPI device addressing information uses a protocol type as a granularity is used as an example. This embodiment is also applicable to DPI device addressing information with another granularity, such as a device granularity or a user granularity, of which an implementation process is basically the same as the process in this embodiment, which is not repeatedly described.

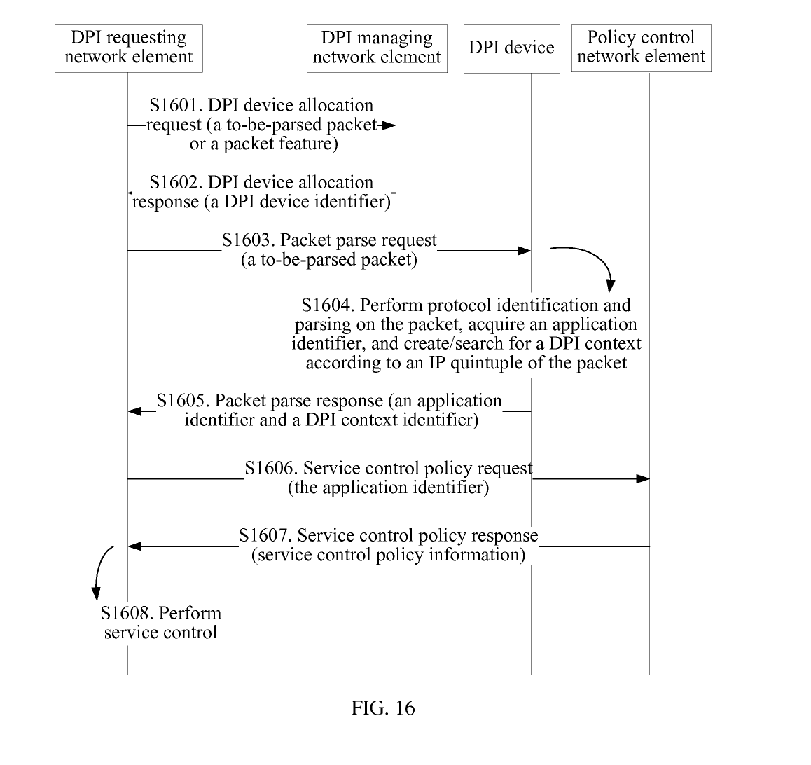

FIG. 16 is an interaction status diagram of a packet control method according to yet another embodiment of the present invention. In this embodiment, DPI device addressing information, an association relationship between an application identifier and a service control policy, and an association relationship between a packet feature and an application identifier are separately acquired from a corresponding control network element.

S1601. A DPI requesting network element sends a to-be-parsed packet or a packet feature (for example, a destination port number, a user or an APN network to which the packet belongs, or an IPv6 Flow Label) of a to-be-parsed packet to a DPI management network element by using a DPI device allocate request message.

S1602. The DPI management network element determines, according to information such as a feature that is of the to-be-parsed packet and carried in the request message, an identifier of a DPI device that provides a DPI service for the service flow, and returns the DPI device identifier to the DPI requesting network element by using a DPI device allocate response message.

S1603. The DPI requesting network element sends, by using a packet parse request, the to-be-parsed packet to a DPI device allocated in step 2, where the packet parse request may optionally include a DPI context identifier.

S1604. The DPI device performs protocol identification or parsing on the packet, and maps a packet identification and parsing result to a corresponding application identifier. Optionally, if the packet parse request message includes a DPI context identifier, the DPI device may further search, according to the DPI context identifier, for a DPI context corresponding to a service flow to which the packet belongs; if acquiring the DPI context successfully, the DPI device performs identification and parsing on the packet according to the DPI context and the to-be-parsed packet. Optionally, the DPI device may further create a DPI context and allocate a context identifier.

S1605. The DPI device returns the application identifier to the DPI requesting network element by using a packet parse response message, where the packet parse response message optionally carries a DPI context identifier.

S1606. The DPI requesting network element sends the application identifier to a policy control network element by using a service control policy request message.

S1607. The policy control network element determines service control policy information related to the application identifier. The policy control network element may determine the service control policy information by configuration or by interacting with another network element, which is not limited in the present invention. The policy control network element returns the service control policy information to the DPI requesting network element by using a service control policy response message, so that the DPI requesting network element performs service control on the packet and a related service flow.

In this embodiment, that DPI device addressing information uses a protocol type as a granularity is used as an example. This embodiment is also applicable to DPI device addressing information with another granularity, such as a device granularity or a user granularity, of which an implementation process is basically the same as the process in this embodiment, which is not repeatedly described.

In this embodiment, step S1601 to step S1602 describe a process of acquiring DPI device addressing information, S1603 to step S1605 describe a process of acquiring a DPI parsing result, and S1606 to step S1607 describe a process of acquiring a service control policy.

The foregoing three steps may use implementation manners of corresponding steps in the foregoing embodiment, so as to implement a combination of various processes, which is not repeatedly described in the present invention.

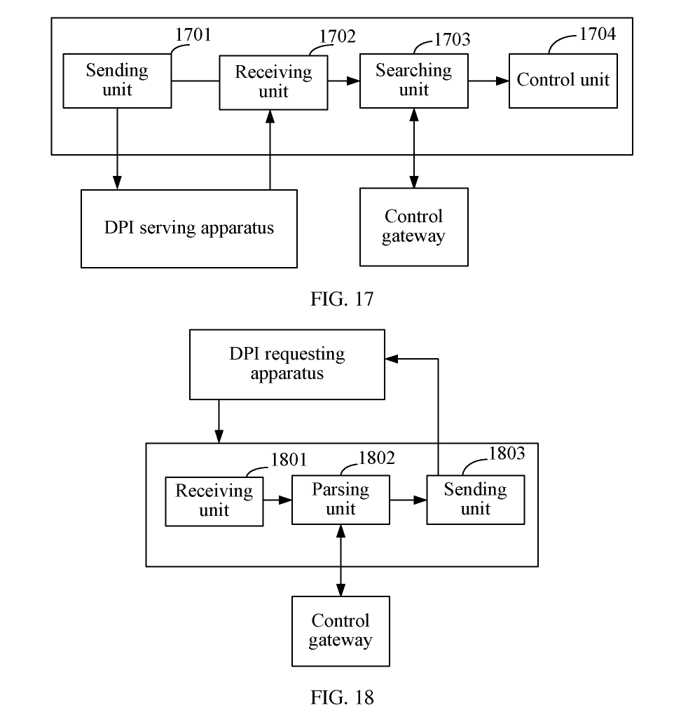

FIG. 17 is a structural diagram of a packet parsing apparatus according to an embodiment of the present invention. It can be seen from the figure that the apparatus includes:

a sending unit 1701, configured to send a packet parse request that includes a to-be-parsed packet to a deep packet inspection DPI serving network element, so that the deep packet inspection DPI serving network element performs deep packet inspection on the to-be-parsed packet and acquires application identifier information corresponding to the to-be-parsed packet;

a receiving unit 1702, configured to receive a packet parse response message that includes application identifier information and is sent by the deep packet inspection DPI device, and send the obtained application identifier information to the searching unit 1703;

the searching unit 1703, configured to acquire application identifier information from the receiving unit 1702, search for a service control policy corresponding to the application identifier information, and send the service control policy obtained by searching to the control unit 1704; and

the control unit 1704, configured to acquire the service control policy from the searching unit, and perform service control on the packet according to the service control policy.

The searching unit 1703 may acquire, in a plurality of manners, the service control policy corresponding to the application identifier information. For example, a configuring unit configures a correspondence between application identifier information and a service control policy locally, and then a service control policy is locally searched for and acquired.

In addition, a control policy may also be acquired in a manner of interacting with a policy control gateway. In this case, the searching unit 1703 further includes: a service control policy requesting subunit, configured to send a service control policy request message that includes the application identifier information to a control gateway, so that the control gateway acquires a service control policy corresponding to the application identifier information; and a response message receiving subunit, configured to receive a service control policy response message that includes the service control policy and is sent by the control gateway.

FIG. 18 is a structural principle diagram of a packet parsing apparatus according to an embodiment of the present invention. It can be seen from the figure that the apparatus includes:

a receiving unit 1801, configured to receive a packet parse request that includes a to-be-parsed packet and is sent by a deep packet inspection DPI requesting network element, acquire the to-be-parsed packet from the packet parse request, and send the to-be-parsed packet to a parsing unit 1802;

the parsing unit 1802, configured to receive the to-be-parsed packet from the receiving unit 1801, parse the to-be-parsed packet, acquire application identifier information corresponding to the to-be-parsed packet, and send the acquired application identifier information to a sending unit 1803; and

the sending unit 1803, configured to acquire the application identifier information from the parsing unit 1802, and send a packet parse response message that includes the application identifier information to the deep packet inspection DPI requesting network element, so that the deep packet inspection DPI requesting network element searches for a service control policy corresponding to the application identifier information.

The parsing unit 1802 acquires an application identifier in two manners. One manner is locally configuring a correspondence between an application identifier and a packet feature, and locally searching for and acquiring the application identifier. The other manner is acquiring the application identifier by interacting with an application identifier control gateway.

In the previous embodiment, the apparatus further includes a configuring unit, configured to locally configure a correspondence between a packet feature and application identifier information.

In the latter solution, the parsing unit 1802 further includes: an application identifier requesting subunit, configured to send an application identifier request to an application identifier gateway according to a parsing result obtained by parsing the to-be-parsed packet; and

a response information receiving subunit, configured to receive application identifier response information that includes the application identifier information and is returned by the application identifier gateway, so as to acquire the application identifier information.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

Steps of methods or algorithms described in the embodiments disclosed in this specification may be implemented by hardware, a software program executed by a processor, or a combination thereof. The software module may be configured in a random access memory (RAM), a memory, a read-only memory (ROM), an electrically programmable ROM, an electrically erasable programmable ROM, a register, a hard disk, a removable disk, a CD-ROM, or a storage medium in any other forms well-known in the art.

The foregoing specific embodiments clarify the objectives, technical solutions, and benefits of the present invention in detail. It should be understood that the foregoing descriptions are merely specific embodiments of the present invention, but are not intended to limit the protection scope of the present invention. Any modification, equivalent replacement, or improvement made without departing from the spirit and principle of the present invention should fall within the protection scope of the present invention.

What is claimed is:

1. A packet control method, comprising:
sending a packet parse request to a deep packet inspection DPI serving network element, wherein the packet parse request comprises a to-be-parsed packet, so that the DPI serving network element performs deep packet inspection on the to-be-parsed packet, and acquires application identifier information corresponding to the to-be-parsed packet;
receiving a packet parse response message sent by the DPI serving network element, wherein the packet parse response message comprises the application identifier information;
searching for a service control policy corresponding to the application identifier information; and
performing service control on the packet according to the service control policy.

2. The packet control method according to claim 1, wherein the searching for a service control policy corresponding to the application identifier information specifically comprises:
sending a service control policy request message to a control gateway, wherein the service control policy request message comprises the application identifier information, so that the control gateway acquires the service control policy corresponding to the application identifier information;
receiving a service control policy response message sent by the control gateway, wherein the service control policy response message comprises the service control policy; and
acquiring the service control policy according to the service control policy response message.

3. The packet control method according to claim 1, before the sending a packet parse request to a deep packet inspection DPI serving network element, further comprising: configuring a correspondence between application identifier information and a service control policy at a local end; and
the searching for a service control policy corresponding to the application identifier information specifically comprises:
searching, according to the correspondence between application identifier information and a service control policy, for the service control policy corresponding to the application identifier information.

4. A packet service control apparatus, comprising:
a sender, configured to send a packet parse request that comprises a to-be-parsed packet to a DPI serving network element, so that the DPI serving network element performs deep packet inspection on the to-be-parsed packet, and acquires application identifier information corresponding to the to-be-parsed packet;
a receiver, configured to receive a packet parse response message that comprises the application identifier information and is sent by the DPI serving network element, and send the obtained application identifier information to a processor;
the processor, configured to acquire application identifier information from the receiver search for a service control policy corresponding to the application identifier information, and perform service control on the packet according to the service control policy.

5. The packet service control apparatus according to claim 4, wherein the processor is further configured to
send a service control policy request message that comprises the application identifier information to a control gateway, so that the control gateway acquires a service control policy corresponding to the application identifier information; and
receive a service control policy response message that comprises the service control policy and is sent by the control gateway.

6. The packet service control apparatus according to claim 4, wherein the processor is further configured to configure a correspondence between application identifier information and a service control policy at a local end.

7. A packet parsing apparatus, comprising:
a receiver configured to receive a packet parse request that comprises a to-be-parsed packet and is sent by a DPI requesting network element, acquire the to-be-parsed packet from the packet parse request, and send the to-be-parsed packet to a processor;
the processor, configured to receive the to-be-parsed packet from the receiver, parse the to-be-parsed packet, acquire application identifier information corresponding to the to-be-parsed packet, and send the acquired application identifier information to a sender; and
the sender, configured to acquire the application identifier information from the processor, and send a packet parse response message that comprises the application identifier information to the DPI requesting network element, so that the DPI requesting network element searches for a service control policy corresponding to the application identifier information.

8. The packet parsing apparatus according to claim 7, wherein the processor is further configured to send an application identifier request to an application identifier gateway according to a parsing result obtained by parsing the to-be-parsed packet; and receive application identifier response information that comprises the application identifier information and is returned by the application identifier gateway, so as to acquire the application identifier information.

9. The packet parsing apparatus according to claim 8, wherein the processor is further configured to locally configure a correspondence between a packet feature and application identifier information.
